(19) United States
(12) Patent Application Publication
(10) Pub. No.: US 2012/0043353 A1
(43) Pub. Date: Feb. 23, 2012

(54) HIGH FLOW AEROSOL VALVE

(75) Inventors: Daniel E. Davideit, Manchester, NH (US); Kevin Verville, Deerfield, NH (US)

(73) Assignee: Summit Packaging Systems, Inc., Manchester, NH (US)

(21) Appl. No.: 12/859,078

(22) Filed: Aug. 18, 2010

(51) Int. Cl. B65D 83/00; B23P 17/04

(52) U.S. Cl. 222/402.1; 29/428

(57) ABSTRACT

The present invention is directed to a valve used in both conventional and bag-on-valve aerosol container applications that allows a high flow rate of especially viscous substances. Valves according to the present invention include a valve housing, a valve stem, and a spring or other biasing device that allows the valve stem to move relative to the valve housing. The valve stem is hollow to allow the flow of product to and from a bag attached to the valve housing. There are radial bores and a seal near the bottom of the valve stem that dictate the passage and flow rate of pressurized product between the product container and the environment. The bore shape and size can be selected to facilitate a high volume flow rate for highly viscous substances.

### FIELD OF THE INVENTION

The present invention relates to a valve, in particular to a high flow aerosol valve used in both standard aerosol and bag-on-valve applications, and particularly to a valve having a housing that is supported by a mounting cup for a product container or can, and communicates with a product or product containment bag inside the can, where the radial opening of the valve is positioned closer to a lower seal of the valve stem rather than an upper seal or mounting cup gasket facilitating an increased flow rate for dispensing the product from the container and valve.

### BACKGROUND OF THE INVENTION

Standard aerosol valve and gasket assemblies for dispensing pressurized product from a container have an inherent structural problem which limits the flow rate of product out of the container and through the valve stem. As is well known, the gasket which seals the conventional radial opening of the spring biased valve in the valve housing of conventional aerosol valves also seals the valve stem with the mounting cup of the container limiting the diameter of the opening relative to the valve stem extending through the gasket. The valve stem is provided with both an axial and a radial opening for dispensing product from the container. When the valve stem is pushed down by a user against a spring bias, the radial opening which is initially blocked by the gasket comes into fluid communication with the product in the container which is then permitted to flow through the radial opening and out the valve stem to the environment. Once the user releases the valve stem, the valve stem is biased back into a closed position with the radial opening blocked by the mounting cup gasket.

The structural problem is two-fold, first the radial opening in the side of the valve stem must be smaller than the thickness of the gasket so that the opening is adequately covered in the closed valve position, otherwise there is a substantial risk of the product being able to escape even when the valve is closed by leakage through the radial opening. The general thickness of a conventional gasket is in the range of 1.02 mm-1.52 mm (0.04-0.06 in.), so the radial openings must be substantially within this range. This along with tolerances necessary to ensure complete closure of the valve limits the size of the radial opening. Secondly, the larger the radial opening is on the upper portion of the valve stem where it is located in such conventional valve stems, the more the structural integrity of the valve stem is affected. If the opening is too large the valve stem when subjected to axial and radial forces during depression by a user can fail and break, bend or otherwise permanently damage the valve stem. Such restrictions in the size of the radial opening in the stem make it difficult to obtain high flow rates of product and a highly viscous product such as toothpaste cannot be dispensed without a sufficiently large passage in the valve stem.

Similarly, in other applications such as bag-on-valve assemblies, such valve stem openings create the same or similar structural issues. Collapsible and highly flexible product bags or pouches have become common in different industries for containing a variety of food, beverage, personal care or household care or other similar products. Such product bags can be used alone to allow a user to manually squeeze and dispense a product from the bag or the product bags may be utilized in combination with a pressurized can and product, for example an aerosol. Such product bags and valves contained in and used with aerosol cans are generally referred to in the aerosol dispensing industry as bag-on-valve (BOV) technology. These product bags, valves and cans may be designed to receive and dispense a desired product in either a liquid or semi-liquid form which have a consistency so as to be able to be expelled from the valve or outlet when desired by the user.

Bag-on-valve technology is known to utilize a product dispenser, such as a can, which has the collapsible product bag inserted therein prior to filling of the bag with a product. The bag is initially flat and inserted axially into the can usually in a rolled up manner and having a filling/dispensing valve communicating with the inside of the product bag. The valve is affixed as in the conventional valve described above to a mounting cup portion of the valve and the mounting cup is crimped to the can. During a final manufacturing phase the product bag is filled with the desired product.

In the filling process, a desired product is inserted into the product bag via the two-way valve by appropriate filling means. When the bag is filled by the filling mechanism, the product bag expands inside the can. At some point in the manufacturing process, the can is provided with a pressurized gas in order to assist in squeezing the bag to expel the contents thereof as is well known in the art. Many factors influence the expulsion of the contents or product from the can out of the valve into the environment. The valve is a key component, which has lead to the design of multiple valve configurations for different applications.

Typically, bag-on-valve applications have used valves that have two components—a valve housing and a valve stem. In most applications, the valve housing engages with a mounting cup of a can, attaches to a bag that holds the product, and provides the framework for the valve stem. The valve stem usually interacts with the valve housing through the use of a spring. The spring allows the valve stem to move relative to the valve housing to open and close the valve. Typically, when the valve is opened, product flows from the product bag, to and through the valve housing, then through a passage in the valve stem, and finally into the environment. The passage is normally limited in size and shape based on the sealing of the passage by the upper gasket that is used to seal the valve housing to the mounting cup.

An issue associated with the bag-on-valve technology is control of the volume flow of the product contents of the bag from the system to the environment. This issue is especially compounded due to the different viscosities of the various products which manufacturers dispense from such bag-on-valve containers. The various product contents include liquids, creams, foams, gels, aerosols, colloids, and various other substances. Handling the flow of a highly viscous substance such as for instance, toothpaste is particularly difficult in both conventional and bag-on-valve applications where the aerosol dispensing radial passages are particularly small in the 1.02 mm-1.52 mm (0.04-0.06 in.) range and there is no structural feasibility to make these holes larger with conventional valve structures. The problem is to be able to accommodate larger dispensing openings in the valve beyond the 1.02 mm-1.52 mm (0.04-0.06 in.) range in order to accommodate higher flow rates and more viscous product.

### OBJECTS AND SUMMARY OF THE INVENTION

The present invention is directed to a valve used in both conventional and bag-on-valve aerosol container applications that allows a high flow rate of especially viscous substances. In a first embodiment of the present invention the valve includes a valve housing, a valve stem, and a spring or other biasing device that allows the valve stem to move relative to the valve housing. The valve stem is substantially hollow to allow the flow of product to and from a bag attached to the valve housing. There is a radial bore or bores and a seal near the bottom of the valve stem that dictate the passage and flow rate of pressurized product between the product container and the environment. The radial bore at the bottom or lower portion of the valve stem provides for flow directly from the product reservoir to the valve stem passage when a lower seal on the valve is opened. The valve stem passage is sealed by the lower seal or ring which is a separate sealing gasket or ring from the upper gasket. The lower seal may be located anywhere along the valve stem below the upper gasket and preferably at the bottom or lower portion of the valve stem facilitating communication to the product reservoir.

As a reference point the upper portion of the valve stem and upper gasket refers to the end of the valve stem and the gasket adjacent the orifice in the mounting cup. The lower portion of the valve stem and the lower gasket or ring are located axially spaced below the upper portion and generally more interior of the container so that product ejected from the container when the valve is actuated travels from the lower portion of the valve stem past the lower gasket or ring up through the upper portion of the valve stem and out of the valve.

The addition of a lower sealing gasket or ring allows one or more larger diameter bore(s) to be radially formed in the lower portion of the valve stem without compromising the integrity of the valve stem itself. The bore shape and larger size can be selected to facilitate a high volume flow rate for highly viscous substances. For example a triangular or polygonal shape could provide a variable flow rate into and through the valve stem to ensure that highly viscous materials are dispensed at a desired flow rate depending on a user's actuation pressure. It is, therefore, an object of the present invention to overcome the above noted issues and produce a valve for both conventional aerosol valve and bag-on-valve systems which facilitates a high volume flow rate for liquids and semi-liquids of different viscosities.

It is another object of the present invention to easily facilitate varying flow rates based on the point of depression of the valve.

It is a still further object of the present invention to provide a high volume flow rate for highly viscous substances that typically have difficulty being dispensed.

It is yet another object of the present invention to simplify the process of adding and discharging the contents of the aerosol can, container or product bag by allowing the product to go directly from the valve stem into the container or product bag without having to pass through the valve housing.

Another object of the present invention is to provide a two-way valve which permits a substantial increase in the speed of filling a product container or bag, especially in the context of highly viscous substances.

The present invention relates to a valve for use in a pressurized aerosol application, the valve comprising a valve housing having an outer surface for supportive engagement with a mounting cup for a product container and a first cavity defined within the valve housing for receiving valve components comprising, a valve stem springingly engaged with the valve housing, the valve stem defining a central passage for dispensing pressurized product to the environment and a lower end portion including a sealing ring for engaging a sealing edge of the valve housing, and at least one radial bore formed in a sidewall of the valve stem located in the lower end portion of the valve stem, the at least one radial bore leading to the central passage extending from the radial bore to a dispensing orifice at an upper end portion of the valve stem.

The present invention also relates to an actuator for an aerosol container comprising a valve housing defining a cavity for receiving valve components comprising an upper portion for engaging a mounting cup for an aerosol container, a chamber for containing a spring, and a lower sealing edge defining an opening into the valve housing; an inner seal between the upper portion of the valve housing and the mounting cup; a valve stem supported within the valve housing and axially moveable relative thereto in accordance with the spring, the valve stem comprising; a passage extending between a radial opening at a lower end of the valve stem and an axial opening at an upper end of the valve stem; and receiving a lower seal supported on the valve stem between the radial opening and a lowermost end of the valve stem.

The present invention also relates to a method of making an actuator for dispensing product from an aerosol container through the actuator comprising the steps of providing a valve housing defining a cavity for receiving valve components comprising the steps of engaging an upper portion of the valve housing in a mounting cup of the aerosol container, forming a chamber for containing a spring, and placing a lower sealing edge defining an opening into the valve housing; providing an inner seal between the upper portion of the valve housing and the mounting cup; supporting a valve stem within the valve housing and axially moveable relative thereto in accordance with the spring, the valve stem comprising the steps of; extending a passage between a radial opening at a lower end of the valve stem and an axial opening at an upper end of the valve stem; and placing a lower seal on the valve stem between the radial opening and a lowermost end of the valve stem.

These and other features, advantages and improvements according to this invention will be better understood by reference to the following detailed description and accompanying drawings.

### BRIEF DESCRIPTION OF THE DRAWINGS

FIG. 1 is a side elevation view of a valve of a first embodiment of the present invention in conjunction with a mounting cup;

FIG. 2 is a perspective view of a first embodiment of the present invention in conjunction with a mounting cup;

FIG. 3 is a cross-sectional view of a valve of the prior art;

FIG. 3A is a cross-sectional view of a first embodiment of the present invention in conjunction with a mounting cup illustrating a fully closed position;

FIG. 3B is a cross-sectional view of a first embodiment of the present invention in conjunction with a mounting cup illustrating a semi-opened position;

FIG. 4 is a side view of a second embodiment of the present invention in conjunction with a mounting cup illustrating a valve with the valve body tip extending beyond the valve housing;

FIG. 5A is a cross-sectional view of a second embodiment of the present invention in conjunction with a mounting cup illustrating a fully closed position;

FIG. 5B is a cross-sectional view of a second embodiment of the present invention in conjunction with a mounting cup illustrating a semi-opened position;

FIG. 6 is a side view of the valve body of the second embodiment of the present invention; and

FIG. 7 is a side view of the valve body with an exemplary bore.

### DETAILED DESCRIPTION OF THE PREFERRED EMBODIMENTS

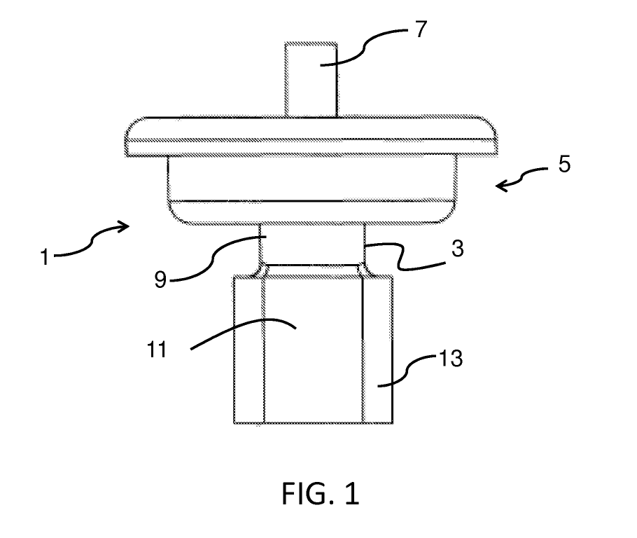

FIG. 1 illustrates a side view of an embodiment of the present invention illustrating the valve 1 in conjunction with the mounting cup 5 for a product containing can or container (not shown) in a bag-on-valve system. The valve stem 7 is parallel with and extends out of the valve housing 3 through the mounting cup 5. The valve housing 3 has multiple sections or portions that correspond to different functions for the bag-on-valve application. As is known in the art, a top portion of the valve housing is engaged generally by crimping with the mounting cup to secure the valve housing 3 to the mounting cup 5. The middle portion of the valve housing 3 is the spring cavity 9, which generally houses a spring for controlling dynamic movement between the valve stem 7 and the valve housing 3. The bottom portion 11 of the valve housing 3 can engage with either a dip tube, or as described in the first embodiment, with a product bag in the case of a bag-on-valve. In the present embodiment the bottom portion 11 seals with a top edge of the product bag B along a fitment 13 and the valve 1 is used to dispense the contents or product from the bag. It is to be appreciated that the valve 1 can be a two-way valve which would allow for product to be inserted into the bag through a filling process as well as dispensed therefrom.

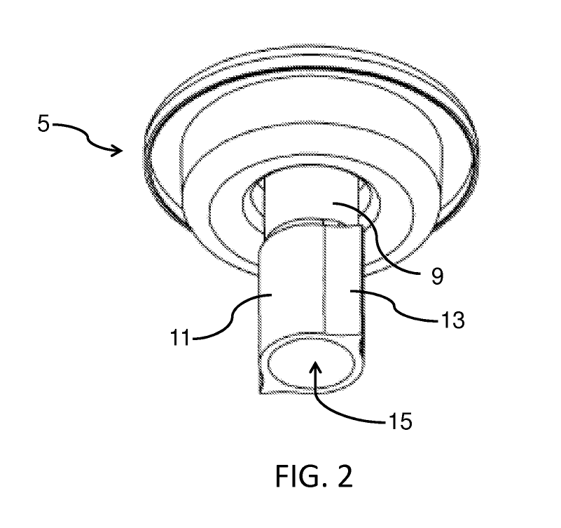

The bottom portion 11 is better illustrated in the perspective view of FIG. 2. The fitment 13 on the bottom portion 11 that assists in the sealing engagement between the base and the product bag is more fully described in Applicant's U.S. patent application Ser. No. 12/667,423 the subject matter of which is herein incorporated by reference. This view also shows the entrance to cavity 15 of the valve housing 3 that receives the product from the bag when a user operates the valve into an open state to dispense the product. The entrance to cavity 15 may or may not communicate with a dip tube which extends down into the lower edges and corners of the bag to facilitate complete product dispensing.

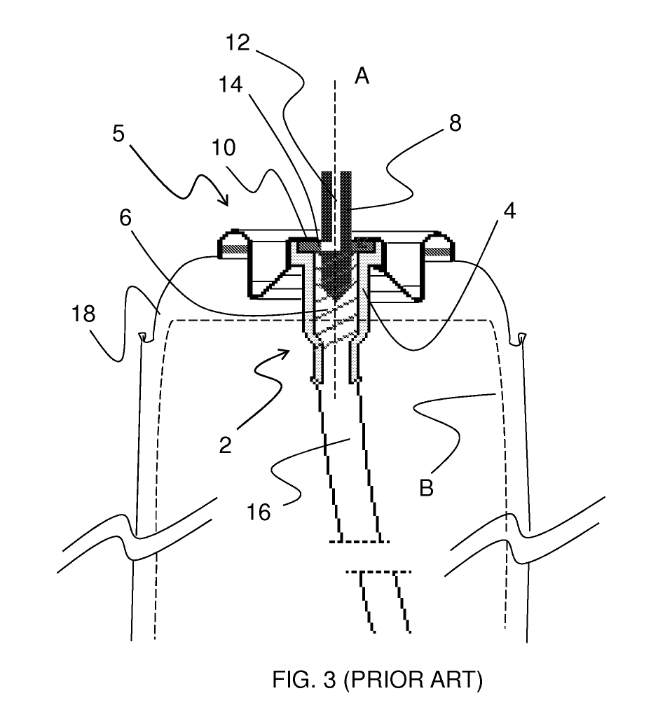

Turning to FIG. 3 a cross-sectional view of a conventional valve 2 of the prior art is shown. The valve 2 having a valve stem 8, a valve housing 4 a valve spring 6 and valve gasket 10 and secured to a mounting cup 5. The valve 2 is actuated by compressing the valve stem 8 and valve spring 6 along axis A to a point below the seal of the gasket 10, so that product may flow from the bag B through the product passage 12 and out from the valve container. The gasket 10 also seals the valve housing 4 to the mounting cup 5. The bag B is within the aerosol container 18. The spring 6 biases the valve 2 in a normally closed position as shown with the opening to the product passage 14 sealed against the gasket 10. In the prior art, product is flowing along the valve housing 4, up and around the valve stem 8 to the product passage 12. The valve 2 may or may not have a dip tube 16.

As shown in FIGS. 3A and 3B, these cross-sectional views of the bag-on-valve embodiment show the valve housing 3 engaged with the mounting cup 5. An inner gasket 29 is used to form a seal between the valve housing cavity 15, the valve stem 7 and the mounting cup 5. The valve stem 7 extends out of the valve housing 3 and through the mounting cup 5 and is axially biased into a closed position by spring 33. The valve stem 7 is provided with an end sealing portion 23 and a product entrance orifice(s) 21 adjacent the end sealing portion 23 of the valve stem 7. The valve stem 7 is axially disposed along axis A through the valve and can be made of for example PET, PTFE or other polymer material known in the art.

The valve stem 7 defines a product passage 19 that extends substantially the entire length of the valve stem 7. The passage 19 starts from a radial bore(s) 21 adjacent a lower end of the valve stem 19. As described in detail below, the location of the bore(s) 21 near the lower end of the valve stem 7 permits a larger bore opening that consequently allows for greater flow of product contents from the product bag relative to conventional valves into the product passage 19 and out of the valve stem 7.

By compressing the valve stem 7 along the axis A the valve is opened as shown in FIG. 3A and product is dispensed through a main opening O at the uppermost end of the valve stem 7. A nozzle or other dispensing device may be added to the valve stem 7 to direct or control product dispersant. At the opposing lower end, the end sealing portion 23 has a circumferential notch or channel 25 adjacent the tip 23 that receives a lower sealing ring 31, gasket, o-ring or some other type of seal including an overmolded seal. The valve housing 3 is formed with a respective ledge 26 on an inner wall to provide a sealing edge 24 against which the sealing ring 31 abuts to close the valve and prevent the flow of product from leaving the product bag while the valve is in a closed state as seen in FIG. 3B.

The valve stem 7 is engaged within the valve housing 3 and biased into the closed state by the use of spring 33 or another biasing device forcing the stem 7 axially upward and into the closed position with the sealing ring 31 closing the valve against the sealing edge 24. It is to be appreciated that although there is no radial opening or bore in the region of the inner gasket 29, the inner gasket 29 provides a seal between the valve housing 3, the sliding valve stem 7 and the mounting cup 5. The spring 33 keeps the valve stem 7 closed so that the product in the product bag cannot communicate with the environment through the valve 1. The spring 33 has an upper end which typically axially engages the valve stem 7 at a lip or stop 27 that extends partially or completely around an outer wall of the valve stem 7. The lower end of the spring 33 is supported by the valve housing 3 at a circumferential edge 28 around the interior wall of the spring cavity 9. The spring 33 bias provided by the spring 33 allows for the depression and movement of the valve stem 7 relative to the valve housing 3 enabling the valve 1 to be varied between an open state as shown in FIG. 3A, to a closed state as in FIG. 3B.

In the open state shown in FIG. 3A, the product in the container is permitted to flow out of the valve and into the environment. The product contents are able to flow from the product bag or container to the valve 1 through the radial bores 21 in the valve stem 7. The radial bores are located at the lower end of the valve stem 7 adjacent the end sealing portion 23 of the valve stem 7. Although the present embodiment shows two oppositely disposed bores 21 in the figures, the valve stem 7 alternatively could have one, or any number of radial bore(s). The bores 21 are located immediately axially adjacent the lower sealing ring 31 and the end sealing portion 23 to allow an instant flow from the product reservoir to the environment through the valve stem 7 without having an intermediary chamber or circuitous flow path through the valve housing. Product ejection occurs when the valve stem 7 is depressed by a user into the open state, moving the valve stem 7 down relative to the valve housing 3 against the spring bias and motivating the lower sealing ring 31 off the ledge 26 which exposes the radial bore(s) 21 directly to the fluid contents of the container.

FIG. 3A illustrates an open state of the valve 1 that allows the bores 21 to communicate directly with a pressurized flow of product from the product reservoir. Previous valves have been known to place such bores and openings to the passageways near the upper portion of the valve stem, which limits the size of the passageway due to the inability to effectively shut a large passage. In the present invention, the product is stopped by the lower sealing ring 31, which allows the passages or bores 21 to be significantly larger than passages in previous valves that are positioned near the upper portion of the stem as opposed to near the lower sealing ring 31 as in the present embodiment. The larger sized bores 21 which can be formed larger than 1.02 mm-1.52 mm (0.04-06 in.) in diameter, are formed closer to the lower sealing ring 31 and allow for a higher volume flow rate of product out of the product reservoir to the environment. As can be seen in the FIGS. 3A-3B, the bores 21, have a significantly larger diameter than the thickness of the upper inner gasket 29. Because of this larger diameter relative to known smaller diameter radial openings adjacent the inner gasket 29, the presently disclosed valve permits a substantially larger flow rate of product to flow into the valve passage 19 when the valve stem 7 is in a semi or fully open position.

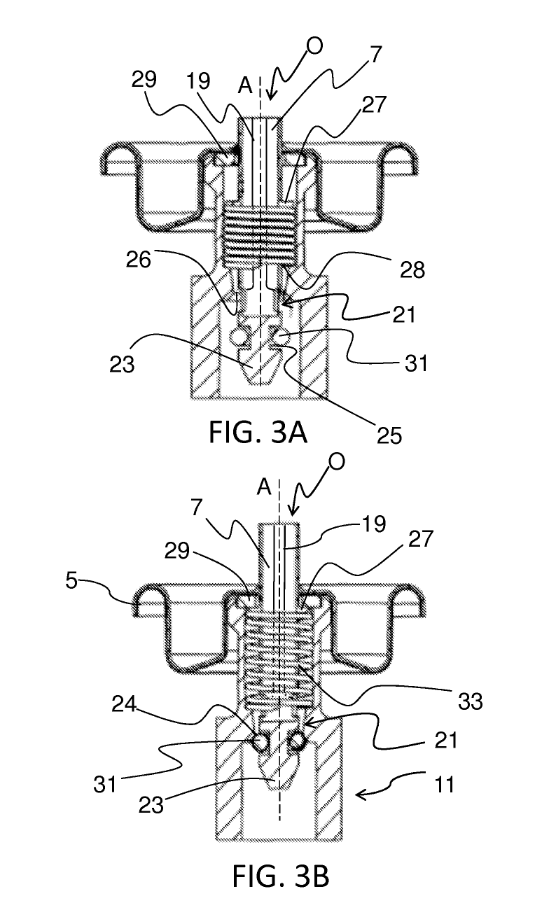

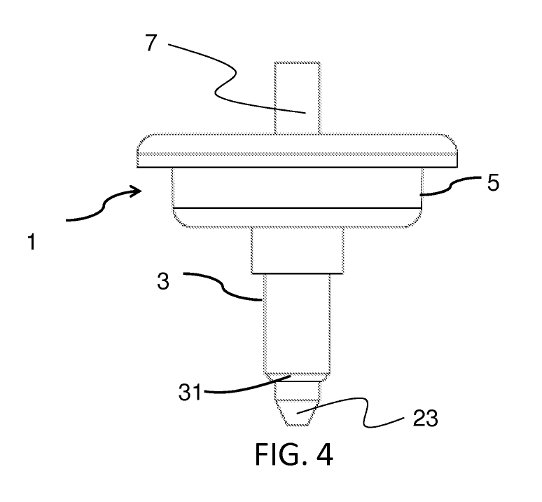

FIGS. 4, 5A, and 5B show a second embodiment of the present invention which is not a bag-on-valve embodiment wherein the fitment for a B-O-V valve is not used and the end sealing portion 23 extends directly into an aerosol container with pressurized fluid product (not shown). It is to be appreciated that a dip tube could also be attached to the end of the valve body 3 for conventional style aerosol container's as necessary. FIG. 5A shows the second embodiment in an open state allowing the product in the product bag to communicate with the valve stem 7 through the bores 35. FIG. 5B shows the second embodiment in a fully closed state with the lower sealing ring 31 preventing product from flowing into the valve stem 7. The bores 35 in this embodiment are shown having a circular profile as opposed to the straight or rectangular profile shown in FIGS. 3A-3B.

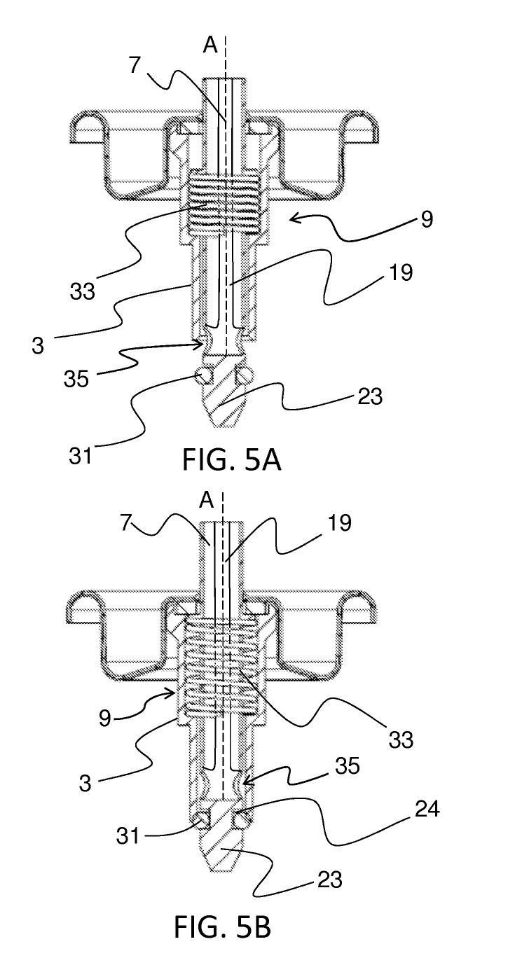

Another important aspect of the present invention is the shape of the bores 35 which can facilitate control over dispensing of product at a high flow rate through the valve. FIG. 6 illustrates a side view of the valve stem 7 of the second embodiment with the bore 35 having a substantially circular shape. The bore 35 is a radial orifice in the sidewall of the valve stem 7, and adjacent the lower end thereof, which can be of a larger diameter than the 1.02 mm-1.52 mm (0.04-0.06 in.) diameter opening conventionally known, for example a diameter of between about 1.02 mm-3.81 mm (0.04-0.15 in) and more preferably in the range of about 2.03 mm-3.05 mm (0.08-0.12 in.) The larger bores 35 do not significantly affect the structural integrity of the valve stem 7 since the bores 35 are close to the bottom end of the valve stem where radial forces from depression and actuation of the valve stem 7 by a user are insignificant. Axial forces can significantly damage the valve stem where the radial opening is located closer to the top end of the valve stem 7 which the user pushes adjacent the inner gasket 29 as in the known valves. The larger bores 35 permit a high amount of product volume to flow at a high flow rate through the passage 19 of the valve stem 7 and travel out to the environment.

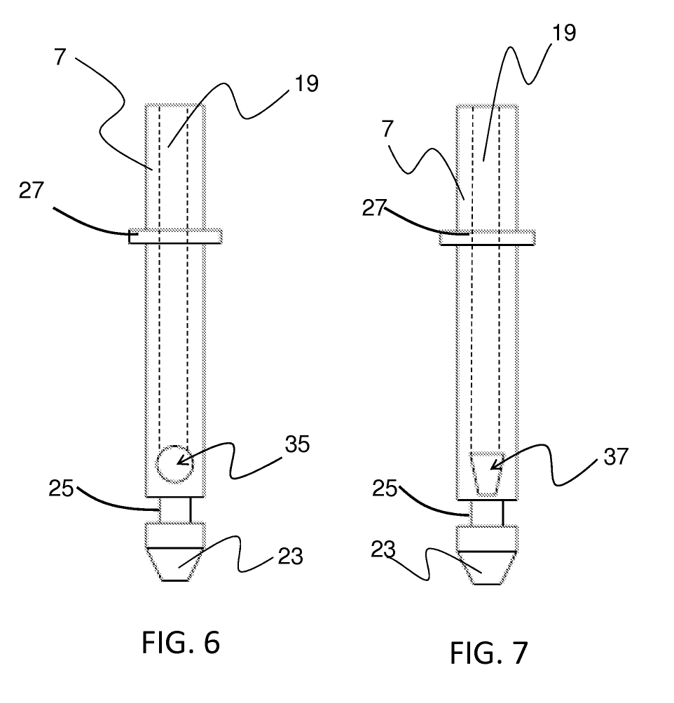

The radial bores or passages can be formed in a desired shape or size to facilitate product flow. In another embodiment of the present invention, the bores are designed to have a profile and area so that depending on how far down the valve stem 7 is pressed relative to the sealing edge 24, a desired variable flow rate can be achieved which depends on how exposed the bore 35 is. Different shapes and sizes may be used for different products and end results. For example, FIG. 7 shows an embodiment of a valve stem 7 having an exemplary radial bore 37 shaped as a polygon, that increases axially in area as the valve stem 7 and bore 37 is moved further axially along relative to the sealing edge 24 of the valve body 3. In the case of the polygon shown in FIG. 7, as the valve stem 7 is pushed axially downwards relative to the sealing edge 24, a larger cross-sectional area of the polygon bore 37 becomes more directly exposed to the product in the container and thus permits an increase in relative product flow the more the valve stem 7 is depressed. The polygon and circular bores shown in these figures are just two examples of the type of larger bore shapes that can facilitate the ability of a user to dispense larger volumes of product at increased flow rates where the bores 35, 37 are located near the bottom end of the valve stem 7.

Since certain changes may be made in the above described improved continuous dispensing actuator assembly, without departing from the spirit and scope of the invention herein involved, it is intended that all of the subject matter of the above description or shown in the accompanying drawings shall be interpreted merely as examples illustrating the inventive concept herein and shall not be construed as limiting the invention.

I/we claim:

1. A valve for use in a pressurized aerosol application, the valve comprising:
a valve housing having an outer surface for supportive engagement with a mounting cup for a product container and a first cavity defined within the valve housing for receiving valve components comprising;
a valve stem springingly engaged with the valve housing, the valve stem defining a central passage for dispensing pressurized product to the environment and a lower end portion including a sealing ring for engaging a sealing edge of the valve housing; and
at least one radial bore formed in a sidewall of the valve stem located in the lower end portion of the valve stem, the at least one radial bore leading to the central passage extending from the radial bore to a dispensing orifice at an upper end portion of the valve stem.

2. The valve of claim 1, further comprising a first radial bore and a second radial bore located in the lower end portion of the valve stem, wherein the first bore is located circumferentially opposite the second bore in the valve stem.

3. The valve of claim 1, wherein the at least one bore in the valve stem axially decreases in cross-sectional area along the valve stem.

4. The valve of claim 1, wherein the at least one bore in the valve stem axially increases in cross-sectional area along the valve stem.

5. The valve of claim 1 wherein the at least one bore in the valve stem is located adjacent the sealing ring at the lower end of the valve stem.

6. The valve stem of claim 1, wherein the lower end portion of the valve stem tip extends past the valve housing into the product container.

7. An actuator for an aerosol container comprising:
a valve housing defining a cavity for receiving valve components comprising;
an upper portion for engaging a mounting cup for an aerosol container,
a chamber for containing a spring, and
a lower sealing edge defining an opening into the valve housing;
an inner seal between the upper portion of the valve housing and the mounting cup;
a valve stem supported within the valve housing and axially moveable relative thereto in accordance with the spring, the valve stem comprising;
a passage extending between a radial opening at a lower end of the valve stem and an axial opening at an upper end of the valve stem; and
receiving a lower seal supported on the valve stem between the radial opening and a lowermost end of the valve stem.

8. The actuator for an aerosol container as set forth in claim 7 further comprising an unactuated position wherein the lower seal on the valve stem is engaged with the lower sealing edge of the valve housing and an actuated position wherein the lower seal is spaced from the lower sealing edge and product in the container can communicate with the radial opening of the valve stem.

9. The actuator for an aerosol container as set forth in claim 7 wherein the radial opening in the valve stem further comprises a first and a second separated radial openings formed in a sidewall of the valve stem.

10. The actuator for an aerosol container as set forth in claim 7 wherein the radial opening in the valve stem increases in cross-sectional area towards the lowermost end of the valve stem.

11. The actuator for an aerosol container as set forth in claim 7 wherein the valve stem is provided with a circumferential slot between the radial opening and the lowermost end of the valve stem for receiving the lower seal.

12. A method of making an actuator for dispensing product from an aerosol container through the actuator comprising the steps of:
providing a valve housing defining a cavity for receiving valve components comprising the steps of;
engaging an upper portion of the valve housing in a mounting cup of the aerosol container,
forming a chamber for containing a spring, and
placing a lower sealing edge defining an opening into the valve housing;
providing an inner seal between the upper portion of the valve housing and the mounting cup;
supporting a valve stem within the valve housing and axially moveable relative thereto in accordance with the spring, the valve stem comprising the steps of;
extending a passage between a radial opening at a lower end of the valve stem and an axial opening at an upper end of the valve stem; and
placing a lower seal on the valve stem between the radial opening and a lowermost end of the valve stem.

13. The method of dispensing product from an aerosol container as set forth in claim 12 further comprising the steps of defining an unactuated position wherein the lower seal on the valve stem is engaged with the lower sealing edge of the valve housing and an actuated position wherein the lower seal is spaced from the lower sealing edge and product in the container can communicate with the radial opening of the valve stem.

14. The method of dispensing product from an aerosol container as set forth in claim 12 further comprising the steps of forming a first and a second separated radial openings formed in a sidewall of the valve stem.
